(19) United States
(12) Patent Application Publication
(10) Pub. No.: US 2026/0134759 A1
(43) Pub. Date: May 14, 2026

(54) COMPUTER-IMPLEMENTED METHOD AND SYSTEM FOR ASYNCHRONOUS MULTIPLAYER MATCHMAKING IN A SKILL-BASED GAME ENVIRONMENT

(71) Applicant: M-LEAGUE LTD., SINGAPORE (SG)

(72) Inventors: Sai Srinivas Kiran GARIMELLA, Bangalore (IN); Sashank VANDRANGI, Bangalore (IN); Rafe Bin MOIN, Bangalore (IN)

(21) Appl. No.: 19/386,895

(22) Filed: Nov. 12, 2025

(30) Foreign Application Priority Data
Nov. 12, 2024 (IN) 202411087156

(51) Int. Cl. G07F 17/32

(52) U.S. Cl. CPC G07F 17/3279; G07F 17/3213; G07F 17/3237; G07F 17/3241

(57) ABSTRACT

The present invention discloses a computer-implemented method (100) including receiving an entry request from a client device, including an associated entry fee. The method (100) further includes determining a predicted performance score for a player by dynamically computing a skill score. The method (100) further includes retrieving a set of timestamped opponent scores submitted within a predefined time window, generating a real-time leaderboard instance including player's rank and the ranks of matched opponents. The method (100) further includes receiving the player's actual score from client device after gameplay. The method (100) further includes updating the player's skill score using an adaptive update function. The method (100) further includes rendering a leaderboard update with a progressive animation reflecting the new ranking position. The method (100) further includes distributing a calculated reward to player's wallet based on their final rank using a dynamic multiplier-based reward distribution logic.

### FIELD OF THE INVENTION

The present invention relates to methods and systems for playing skill based leader board game. More particularly, the present invention relates to a computer-implemented method and system for asynchronous multiplayer matchmaking in a skill-based game environment.

### BACKGROUND OF THE INVENTION

In the world of multiplayer gaming, players constantly seek a competitive and enjoyable experience that tests their skills against equally matched opponents. Traditional systems like ELO and TRUESKILL have been widely used to rank players based on their wins and losses over time. These algorithms work by analyzing game data and generating skill ratings, which help match players with opponents of similar skill levels, enhancing both competition and fairness.

As online gaming evolved, tournaments became a popular way for players to compete on a larger scale. Players typically pay an entry fee to participate in these tournaments, where they are scheduled to play matches at specific times determined by the tournament organizers. However, this rigid scheduling often proves inconvenient for players, who may struggle to meet the required times due to personal constraints.

The current tournament systems, while effective for smaller competitions, begin to falter when scaled to include hundreds of thousands or even millions of players. The time and logistical challenges of organizing such large-scale events lead to player frustration, limited participation, and potential delays in tournament progress.

In addition to scheduling difficulties, traditional tournament formats often lead to dissatisfaction among players of varying skill levels. High-skill players may feel burdened by having to play multiple rounds against weaker opponents, which they perceive as a waste of time. Conversely, lower-skilled players might feel discouraged, knowing they have little chance to compete against much stronger participants. This mismatch of skill levels throughout a tournament diminishes the enjoyment for all participants, reducing the overall appeal of competitive gaming environments.

Leaderboards, which track and rank top players based on their performance, have become another important feature in online gaming. However, the sheer volume of players in modern games makes it challenging to update these rankings in real-time. As the number of players grows, the process of recalculating and sorting ranking scores becomes increasingly slow, leading to delays in leaderboard updates. Players who need timely feedback on their rankings, such as those purchasing in-game equipment or making strategic decisions, are left waiting for updates, which negatively affects their overall game experience.

To address these challenges, there is a clear need for a more flexible, scalable, and accurate system that not only accommodates large numbers of players but also provides a fair and efficient way to rank and match them based on a broader range of performance metrics. By enhancing the ranking systems to better reflect individual contributions during gameplay and offering a more dynamic approach to tournament scheduling, this invention seeks to improve the gaming experience, foster longer player engagement, and ultimately increase satisfaction for participants of all skill levels.

Various prior art has tried to overcome the aforementioned challenges of the multiplayer gaming. For example, the US publication number 20130324214, discloses a gaming system consisting of a game of chance unit, a skill unit, and a skill gaming unit. When a predefined scenario occurs in the game of chance, the system requests a bonus round session from the skill unit. The skill game is played by the player during the bonus round, and the score achieved in the skill game is sent back to the game of chance unit, integrating the results into the ongoing gameplay. This system allows for a seamless transition between chance and skill elements, enhancing player engagement.

Further, another prior art, U.S. publication Ser. No. 11/640,749, disclose a gaming machine and methods for providing a skill-based wagering game. The machine includes a display device, a user input device for receiving player inputs and wagers, a memory device storing Return to Player (RTP) data, and a controller that manages the game. The controller initiates the game after receiving a wager, tracks the player's skill during gameplay, and determines an RTP value based on the player's skill level and wager amount. It then generates potential awards, presents them to the player, and adjusts the player's credit balance based on the selected award.

Some other prior art that the inventors have identified are as follows:

The U.S. publication Ser. No. 11/620,877 disclose a skill-based wagering games, systems, and devices where the game's configuration is adjusted based on the player's skill level. In one embodiment, the odds of winning, the required entry fee or wager, and the payout for winning outcomes are all dependent on the player's skill. For example, players with higher skill levels may receive lower payouts or be required to pay higher entry fees for achieving the same outcome as less skilled players. Alternatively, in some embodiments, the payouts and entry fees may remain fixed, but the difficulty of achieving a winning outcome is adjusted based on the player's skill level.

Moreover, the other prior art CN publication number 115845395 discloses a method and apparatus for updating a gaming ranking list based on player performance. Upon receiving a rank refresh request, the method calculates the player's ranking score from their game data and checks the current list for any players with lower scores to establish the player's target rank. The score is positioned between adjacent ranks, and outdated scores may be removed as new scores are inserted. The process includes verifying the legitimacy of the device submitting the request, ensuring only valid data is used, and calculating wait times for updates while managing user feedback. The apparatus consists of modules for determining scores, querying rankings, and processing updates, with a computer-readable medium available for storing instructions to implement this ranking update method.

Furthermore, another prior art U.S. publication Ser. No. 11/103,788 discloses a methods and systems for matchmaking players in online gaming, focusing on compensating for the disadvantages streaming players face due to network latency and bandwidth limitations. The system adjusts matchmaking by calculating a modified skill score for streaming players, which considers their network conditions. This modified score is typically lower than the original skill score, allowing for fairer matches with non-streaming players who have lower skill levels. Additionally, the system considers the type of input device used by streaming players, as this can impact responsiveness. By employing Streaming Latency Skill Compensators (SLSCs) and Streaming Input Device Skill Compensators (SIDSCs), the matchmaking system aims to create a more equitable gaming experience for all players.

Another prior art U.S. publication Ser. No. 12/027,008 discloses a systems and methods for conducting multiplayer gaming tournaments using electronic gaming machines (EGMs). In these tournaments, players' scores determine their rankings, displayed on leaderboards that can feature a graphical, race-style presentation for engaging visual appeal. Two formats are available: player-agnostic leaderboards for spectators, showing all or selected players, and player-centric leaderboards that provide tailored information relevant to individual players, such as current rankings and score differentials. The electronic gaming system, equipped with processors and memory, executes instructions to manage the leaderboard, updating player positions in real-time based on their performance metrics, thus enhancing player engagement during EGM tournaments.

Moreover, the other prior art U.S. publication Ser. No. 11/517,824 discloses a dynamic events-based ranking system aimed at improving player rankings and skill scores in video games by evaluating discrete in-game events. This system identifies specific events, gathers data, and assesses individual player contributions, leading to the creation of sub-scores that contribute to a more accurate overall skill score, reflecting a player's abilities with fewer games played. By partitioning games into manageable events such as “rounds” and “encounters,” the system can track player performance in real-time, enabling rapid score adjustments and accurate rankings. This innovative approach not only enhances individual player assessments but also refines team rankings, achieving reliable results in significantly less time compared to traditional ranking methods. The disclosure emphasizes flexibility, allowing various components to be tailored without limiting the system's overall effectiveness, and provides a detailed understanding of the technologies involved, including hardware, firmware, and software configurations.

Furthermore, the US publication number 20070112706 discloses a method and system for adjusting a player's skill score in a gaming environment through the incorporation of one or more handicaps, thereby generating a handicapped skill score. This adjusted score is used to match the player with others for gameplay, ensuring more balanced and competitive matches. The handicaps can be based on various game-induced or system-induced factors, and they represent the predicted effects of these factors on player performance. The method includes operations for updating both the player's skill score and the handicaps based on the outcomes of matches.

However, still in the state of the art, there are persistent challenges of developing more efficient and fair tournament systems that can accommodate large-scale online events. The process of updating leaderboards in large tournaments introduces delays. Traditional leaderboards are updated periodically, recalculating scores for all players and ranking them accordingly. With thousands of participants, this can result in slow leaderboard updates, taking minutes or even hours to refresh. Players who rely on real-time rankings for strategic decisions or purchasing in-game equipment are left waiting, which negatively impacts their gaming experience.

The present invention overcomes several issues in traditional ranking and matchmaking systems by offering real-time, dynamic updates and fairer matchmaking. Unlike conventional systems that can match players against opponents of vastly different skill levels, the present invention uses recent scores to pair players with similarly skilled competitors in near real-time, ensuring a more balanced experience. It also provides instant leaderboard updates, placing players on a Hall of Fame immediately after a match, which enhances engagement. The skill score system is tailored for both new and seasoned players, preventing manipulation and ensuring accurate rankings.

In a nutshell, a method and computer-implemented method and system for playing leader board skill-based game which may overcome the above discussed drawbacks and problems and provide easy and efficient way of playing the said games.

### SUMMARY OF THE INVENTION

In an aspect of the present invention, a computer-implemented method for asynchronous multiplayer matchmaking in a skill-based game environment is disclosed.

In the embodiment of the present invention, the first step of the method involves receiving, via a network interface, an entry request from a client device, including an associated entry fee.

Moreover, the transitions are detected in entry fee tiers for a player and applying a smoothing function to the skill score when the player first participates in a higher fee tier to reduce abrupt fluctuations.

In another embodiment of the present invention, the followed step of the method involves determining a predicted performance score for a player by dynamically computing a skill score, the skill score being updated using a combination of the player's historical average score and the deviation between actual and predicted performance.

Moreover, the effective weight of a player's historical scores in skill score computation is reduced when the player remains inactive beyond a predefined inactivity threshold, by applying a decay factor.

In another embodiment of the present invention, the followed step of the method involves retrieving from a time-restricted score database, a set of timestamped opponent scores submitted within a predefined time window, selected to fall within predefined bands around the predicted performance score.

Moreover, the retrieval of opponent scores is constrained to a defined time window (T) and comprising cancelling the matchmaking attempt if suitable scores are not identified within the time window T or falling back to alternative score bands if no matches are available in the initial bands. The time-window constraint mitigates fraudulent gameplay by ensuring opponent scores originate from recent and valid gameplay sessions.

Furthermore, the matchmaking score bands are dynamically adjusted based on real-time analysis of return-to-player (RTP) metrics and a predefined RTP target value for experienced players.

In another embodiment of the present invention, the followed step of the method involves generating on the client device, a real-time leaderboard instance including the player's rank and the ranks of matched opponents.

In another embodiment of the present invention, the followed step of the method involves receiving the player's actual score from the client device after gameplay.

In another embodiment of the present invention, the followed step of the method involves updating the player's skill score using an adaptive update function, wherein different update logic is applied based on whether the player has played more or fewer than a threshold number of games.

Moreover, the adaptive skill score update comprises for players with fewer than ten recorded games, calculating a rolling average of scores scaled by a constant factor (k₁) to mitigate outliers and for players with ten or more games, computing a predicted_score as predicted_score=skill_score×l₁, and updating the skill score using skill_score_new=skill_score+α×(actual_score−predicted_score)×entry fee, where α is a learning rate constant. The constants (α, k₁, l₁) are dependent on computation of numbers at the user level.

Furthermore, the access to high-entry-fee gameplay contests is restricted until the player has completed a predefined minimum number of games and exhibits a skill score variance within a predefined acceptable deviation range. Absolute integers are used in the range [0, N], where N represents the theoretical maximum score for the game.

In another embodiment of the present invention, the followed step of the method involves rendering a leaderboard update with a progressive animation reflecting the new ranking position.

Moreover, the leaderboard is updated using a progressive animation sequence that visually represents the rank changes by cached delta score values, reducing the amount of data transmitted between server and client and minimizing latency. The implementation uses an application programming interface (API) call through which the backend service (Java) fetches the numbers from the data science (Machine Learning (ML) platform). The ML platform provides the targets based on user skill scores, which are then rendered within the unity game environment as score targets for the user to beat.

Furthermore, rendering a leaderboard comprising thematically rendering the leaderboard as a hall-of-fame podium; associating each matched opponent score with a timestamp and corresponding skill level; and displaying an entry animation that visually represents the player displacing the lowest-ranked score on the leaderboard.

In another embodiment of the present invention, the followed step of the method involves distributing a calculated reward to the player's wallet based on their final rank using a dynamic multiplier-based reward distribution logic. The method ensures fair asynchronous gameplay by adapting opponent selection and leaderboard generation without requiring concurrent player participation.

Moreover, the distribution of rewards comprising dynamically calculating prize rewards based on a fixed leaderboard size, wherein each position on the leaderboard is associated with a preconfigured multiplier, and the multiplier is applied to the player's entry fee to determine the reward amount. The prize structure is configured that a player must beat a minimum number of opponents to recover their entry fee.

In one embodiment of the present invention, a computer-implemented system for asynchronous multiplayer matchmaking in a skill-based gaming environment is disclosed.

In another embodiment of the present invention, a system comprises a player profile database configured to store each player's skill score, gameplay history, and timestamped game scores.

Moreover, the player profile database comprises a score integrity engine configured to validate submitted player scores against server logs, flag statistically anomalous scores for manual review and prevent storage of tampered scores in the database.

In another embodiment of the present invention, the system further comprises a matchmaking engine configured to compute a predicted score for a player based on the player's current skill score and a scaling factor, retrieve historical opponent scores submitted within a predefined time window, select opponent scores falling within two bands a lower band (0.8×-1.0×) and an upper band (1.0×-1.5×) of the predicted score, and fallback to the other band if insufficient scores are found in one band, and accordingly cancel the match if sufficient scores are not found in total.

Moreover, the matchmaking engine comprises a score decay engine configured to detect player inactivity beyond a defined threshold and apply a decay function for reducing the influence of historical scores in skill score calculations.

In another embodiment of the present invention, the system further comprises a leaderboard engine configured to generate a leaderboard view including the player and matched opponent scores and render progressive animation representing rank changes using minimal delta data.

Moreover, the leaderboard engine includes a user interface (UI) rendering module configured to display matched scores in a hall-of-fame podium layout which is associate each score with timestamp and recorded skill level and animate player entry using displacing a lower-ranked opponent on the podium.

In another embodiment of the present invention, the system further comprises a skill evaluation engine configured to update player skill scores based on match outcomes by dynamic update logic. The skill evaluation engine is configured to initialize a default skill score for new players, apply different update strategies based on a game count threshold and scale is updated according to actual score, predicted score, and entry fee, by a corrective learning constant.

Moreover, an RTP optimization engine configured to monitor RTP metrics across player cohorts and accordingly adjust matchmaking score bands dynamically to maintain RTP near a predefined target value.

In another embodiment of the present invention, the system further comprises a reward distribution engine configured to allocate players winnings based on final leaderboard position and a multiplier function tied to entry fee.

Moreover, the multiplier function comprising a tiered access manager configured to classify players into entry fee tiers based on skill score and gameplay count and regulate the entry and transition between the tiers based on win-rate, score variance, and consistency metrics.

In another embodiment of the present invention, the system further comprises a fraud detection engine configured to compute an anomaly score for each submitted game session.

Moreover, the anomaly score is derived from a combination of a timestamp compares submission time patterns with predefined time window for the player cohort, and a gameplay pattern aids in evaluating the deviations in metrics such as player's performance, score rate and gameplay behavior.

This together with the other aspects of the present invention along with the various features of novelty that characterize the present disclosure is pointed out with particularity.

For a better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1 illustrates a flow chart of the leader board skill-based game, according to various embodiments of the present invention;

FIG. 2 illustrates a block diagram showing a system of a gameplay, according to various embodiments of the present invention;

FIG. 3 illustrates a dynamic interface of a real-money skill-based gaming system, according to various embodiments of the present invention; and

FIG. 4 illustrates a leaderboard interface of gameplay “hall-of-fame” and gameplay “Beat the Score”, according to various embodiments of the present invention; and

FIG. 5 illustrates a winning leaderboard interface of gameplay, according to various embodiments of the present invention;

FIG. 6 illustrates a flow chart of a skill score update mechanism, according to various embodiments of the present invention;

FIG. 7 illustrates a flow chart of a match band selection and fallback logic, according to various embodiments of the present invention; and

FIG. 8 illustrates a flow chart of a delta leaderboard rendering and caching strategy, according to various embodiments of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to as disclosed.

It is understood that various omissions and substitutions of equivalents are contemplated as circumstances may suggest or render expedient, but these are intended to cover the application or implementation without departing from the spirit or scope of the present invention.

Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

More specifically, the technical terms used herein are to be understood as commonly known by those skilled in the field.

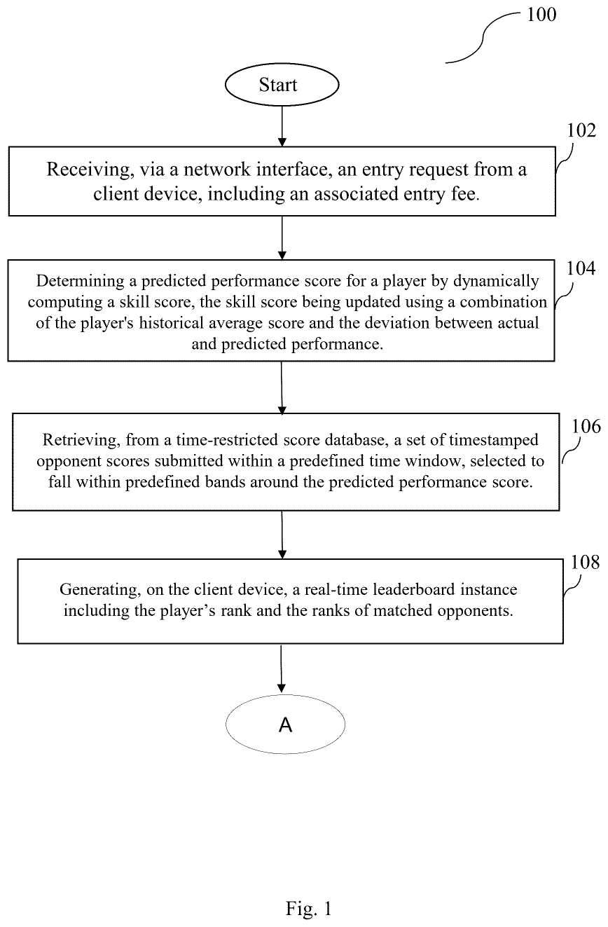

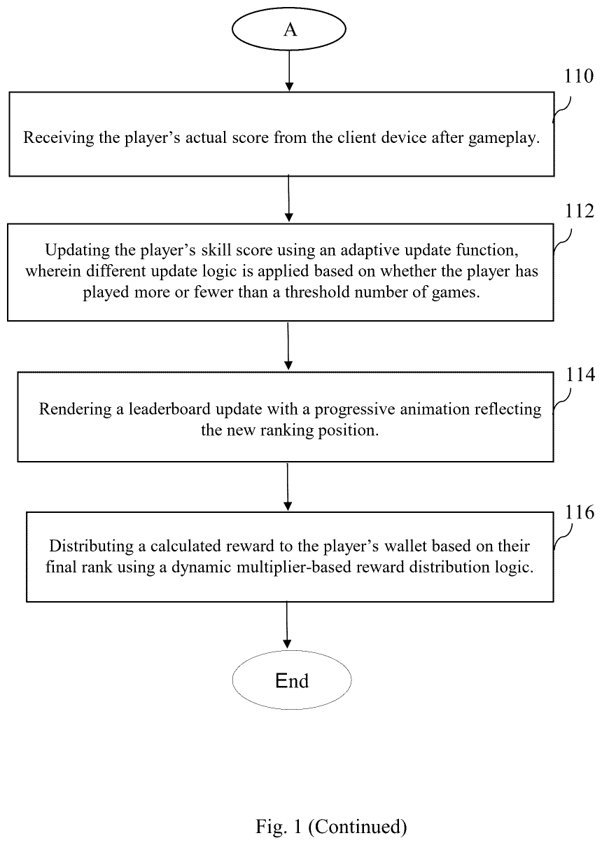

The inventive aspects of the invention along with various components and engineering involved will now be explained with reference to FIGS. 1-8 herein.

In an aspect of the present invention, a computer-implemented method (100) for asynchronous multiplayer matchmaking in a skill-based game environment is disclosed.

Referring to FIG. 1, the method (100) begins with step 102, which involves receiving, via a network interface, an entry request from a client device, including an associated entry fee.

Moreover, the transitions are detected in entry fee tiers for a player and applying a smoothing function to the skill score when the player first participates in a higher fee tier to reduce abrupt fluctuations.

Referring to FIG. 1, the method (100) follows with step 104, which involves determining a predicted performance score for a player by dynamically computing a skill score, the skill score being updated using a combination of the player's historical average score and the deviation between actual and predicted performance.

Moreover, the effective weight of a player's historical scores in skill score computation is reduced when the player remains inactive beyond a predefined inactivity threshold, by applying a decay factor.

Referring to FIG. 1, the method (100) follows with step 106, which involves retrieving from a time-restricted score database, a set of timestamped opponent scores submitted within a predefined time window, selected to fall within predefined bands around the predicted performance score.

Moreover, the retrieval of opponent scores is constrained to a defined time window (T) and comprising cancelling the matchmaking attempt if suitable scores are not identified within the time window T or falling back to alternative score bands if no matches are available in the initial bands. The time-window constraint mitigates fraudulent gameplay by ensuring opponent scores originate from recent and valid gameplay sessions.

Moreover, the falling back ensures fair, recent, and competitive matchmaking in asynchronous play when real-time players are not present. The mechanism for predicted score computation is predicted_score=skill_score×scaling constant (l), and target opponent score bands i.e., lower band: 0.8× to 1.0χ of predicted score and upper band: 1.0× to 1.5× of predicted score.

Furthermore, the scores which are submitted within a specific and recent time period (e.g., 1 hour) are considered. If sufficient scores are not found in one band, then the scores are filled from the other band. If total required scores (e.g., 5 opponents) are still not met then the match is cancelled and notify player to retry later.

Moreover, the score is considered as fraudulent if it is not traceable to a verified session, submitted outside the allowed time window, and implausibly high or low based on the player's skill history. In server logs, every gameplay session is logged onto the server (timestamp, duration, input pattern). If no matching session exists, the player score is flagged. Similarly, in timestamp logs, only scores within valid matchmaking time window (T) are accepted and in anomaly score, the statistical models compute an anomaly score based on deviation from player's normal performance, score rate, and gameplay behavior and the outliers are flagged.

Furthermore, the matchmaking score bands are dynamically adjusted based on real-time analysis of return-to-player (RTP) metrics and a predefined RTP target value for experienced players.

Referring to FIG. 1, the method (100) follows with step 108, which involves generating on the client device, a real-time leaderboard instance including the player's rank and the ranks of matched opponents.

Referring to FIG. 1, the method (100) follows with step 110, which involves receiving the player's actual score from the client device after gameplay.

Referring to FIG. 1, the method (100) follows with step 112, which involves updating the player's skill score using an adaptive update function, wherein different update logic is applied based on whether the player has played more or fewer than a threshold number of games.

Moreover, the adaptive skill score update comprises for players with fewer than ten recorded games, calculating a rolling average of scores scaled by a constant factor (k₁) to mitigate outliers and for players with ten or more games, computing a predicted_score as predicted_score=skill_score×l₁, and updating the skill score using skill_score_new=skill_score+α×(actual_score−predicted_score)×entry fee, where α is a learning rate constant. The constants (α, k₁, l₁) are dependent on computation of numbers at the user level.

Furthermore, the access to high-entry-fee gameplay contests is restricted until the player has completed a predefined minimum number of games and exhibits a skill score variance within a predefined acceptable deviation range. Absolute integers are used in the range [0, N], where N represents the theoretical maximum score for the game.

Referring to FIG. 1, the method (100) follows with step 114, which involves rendering a leaderboard update with a progressive animation reflecting the new ranking position.

Moreover, the leaderboard is updated using a progressive animation sequence that visually represents the rank changes by cached delta score values, reducing the amount of data transmitted between server and client and minimizing latency. The implementation uses an application programming interface (API) call through which the backend service (Java) fetches the numbers from the data science (Machine Learning (ML) platform). The ML platform provides the targets based on user skill scores, which are then rendered within the unity game environment as score targets for the user to beat.

Furthermore, rendering a leaderboard comprising thematically rendering the leaderboard as a hall-of-fame podium; associating each matched opponent score with a timestamp and corresponding skill level; and displaying an entry animation that visually represents the player displacing the lowest-ranked score on the leaderboard.

Referring to FIG. 1, the method (100) follows with step 116, which involves distributing a calculated reward to the player's wallet based on their final rank using a dynamic multiplier-based reward distribution logic. The method (100) ensures fair asynchronous gameplay by adapting opponent selection and leaderboard generation without requiring concurrent player participation.

Moreover, the distribution of rewards comprising dynamically calculating prize rewards based on a fixed leaderboard size, wherein each position on the leaderboard is associated with a preconfigured multiplier, and the multiplier is applied to the player's entry fee to determine the reward amount. The prize structure comprises a refund trigger module which refund the entry fees if score exceeds a threshold rank within selected prediction bands.

In an exemplary embodiment of the present invention, the system (200) comprises a reward distribution engine (210) to allocate winnings based on final leaderboard position and a multiplier function tied to entry fee. After the completion of each game session, each leaderboard position is associated with a predefined multiplier. The system (200) calculates each player's reward by multiplying their entry fee via multiplier for their final rank.

Moreover, a refund trigger module is integrated into the reward distribution engine (210). The refund trigger module monitors the condition such as the player's final score exceeds a defined threshold, and the opponent scores are matched from a specific prediction band. If the above-mentioned conditions are met, the system (200) accordingly refunds the entry fee of the player.

In one embodiment of the present invention, a computer-implemented system (200) for asynchronous multiplayer matchmaking in a skill-based gaming environment is disclosed.

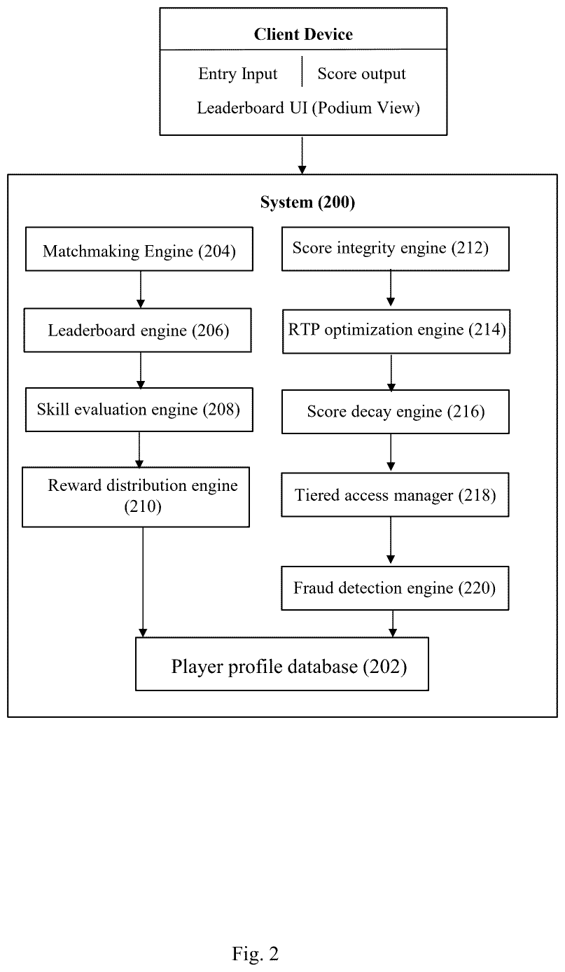

Referring to FIG. 2, a system (200) comprises a player profile database (202) configured to store each player's skill score, gameplay history, and timestamped game scores.

Moreover, the player profile database (202) comprises a score integrity engine (212) configured to validate submitted player scores against server logs, flag statistically anomalous scores for manual review and prevent storage of tampered scores in the database.

Referring to FIG. 2, the system (200) further comprises a matchmaking engine (204) configured to compute a predicted score for a player based on the player's current skill score and a scaling factor, retrieve historical opponent scores submitted within a predefined time window, select opponent scores falling within two bands a lower band (0.8×-1.0×) and an upper band (1.0×-1.5×) of the predicted score, and fallback to the other band if insufficient scores are found in one band, and accordingly cancel the match if sufficient scores are not found in total.

Moreover, the matchmaking engine (204) comprises a score decay engine (216) configured to detect player inactivity beyond a defined threshold and apply a decay function for reducing the influence of historical scores in skill score calculations.

Referring to FIG. 2, the system (200) further comprises a leaderboard engine (206) configured to generate a leaderboard view including the player and matched opponent scores and render progressive animation representing rank changes using minimal delta data.

Moreover, the leaderboard engine (206) includes a user interface (UI) rendering module configured to display matched scores in a hall-of-fame podium layout which is associate each score with timestamp and recorded skill level and animate player entry using displacing a lower-ranked opponent on the podium.

Referring to FIG. 2, the system (200) further comprises a skill evaluation engine (208) configured to update player skill scores based on match outcomes by dynamic update logic. The skill evaluation engine (208) is configured to initialize a default skill score for new players, apply different update strategies based on a game count threshold and scale is updated according to actual score, predicted score, and entry fee, by a corrective learning constant.

Moreover, an RTP optimization engine (214) configured to monitor RTP metrics across player cohorts and accordingly adjust matchmaking score bands dynamically to maintain RTP near a predefined target value.

Referring to FIG. 2, the system (200) further comprises a reward distribution engine (210) configured to allocate players winnings based on final leaderboard position and a multiplier function tied to entry fee.

Moreover, the multiplier function comprising a tiered access manager (218) configured to classify players into entry fee tiers based on skill score and gameplay count and regulate the entry and transition between the tiers based on win-rate, score variance, and consistency metrics.

Referring to FIG. 2, the system (200) further comprises a fraud detection engine (220) which is configured to compute an anomaly score for each submitted game session. The anomaly score is derived from a combination of a timestamp compares submission time patterns with predefined time window for the player cohort and a gameplay pattern evaluates deviations in metrics such as player's performance, score rate and gameplay behavior.

Referring to FIG. 2, the system (200) data flow is initiated when a new player buys into a game, the matchmaking engine (204) is activated, and the gameplay session is started. The matchmaking engine (204) queries the player profile database (202) which contains timestamped scores and skill levels of previous players. The matchmaking engine (204) retrieves the opponent scores that fall within two bands a lower band (0.8×-1.0×) and an upper band (1.0×-1.5×) of the predicted score by using the entering player's predicted score.

Moreover, once the opponent scores are selected, the matchmaking engine (204) passes this data to the leaderboard engine (206) to create a visual leaderboard in a hall-of-fame podium layout, which is displayed to the player as the game is played. Post the player finishes the game, their score is sent back to the leaderboard engine (206), which updates the leaderboard with an animation, placing the player in their final ranked position using minimal delta data. The ranking data is then sent to the skill evaluation engine (208) and the reward distribution engine (210).

Furthermore, the skill evaluation engine (208) processes the player's performance against their predicted score. For players with fewer than ten recorded games, calculating a rolling average of scores scaled by a constant factor (k₁) to mitigate outliers and for players with ten or more games, computing a predicted score as predicted_score=skill_score×l₁. The updated skill score is then stored back in the player profile database (202) for use in future matchmaking during the gameplay.

Moreover, the reward distribution engine (210) takes the player's final leaderboard position as input and applies a multiplier function to calculate the winnings. The final computed reward is then sent to the player's wallet, thereby completing the transaction.

In an exemplary embodiment of the present invention, the reward distribution engine (210) is configured to evaluate the player's final rank relative to a dynamically constructed leaderboard comprising previously submitted scores within a defined prediction range. If the player's final score is ranked within the top [n] positions based on a score threshold comparator, a refund trigger module is invoked to return the base entry fee. Otherwise, the reward is computed using a multiplier logic based on the entry tier and deviation from matched opponent scores.

In an exemplary embodiment of the present invention, the system (200) flow is initiated as a player named A joins in a multiplayer leaderboard challenge game with a USD of 1. Player A is relatively new user who has completed only three games so far. Based upon account creation, player A is assigned a default skill score of 3000.

After the three games, the skill score is calculated as:

$$skill score = k \times average rolling scores from game s 1 - 3$$

where k is scaling constant, value of k is 0.5, and players' average score is 6200.

$$skill score = 0.5 \times 6200 = 3100$$

The system (200) computes player's A predicted score:

$$predicted\_score = skill score \times 1 = 3100 \times 1 = 3100 ( Assume l = 1 )$$

Moreover, the matchmaking engine scans the player profile database for historical scores from other players submitted within the past 1 hour, targeting two score bands:

$$Lower band : 0.8 x - 1. x predicted score = 0.8 \times 3100 - 1 \times 3100 = 2480 - 3100$$

$$Upper band : 1. x - 1.5 x predicted score = 1 \times 3100 - 1.5 \times 3100 = 3100 - 4650$$

Moreover, with timestamped entries, it finds two scores in the lower band and three in the upper band. The opponents' skill ratings at the point of submission, along with the scores, are grouped into a leaderboard instance.

Furthermore, player A is presented with the “hall-of-fame” leaderboard interface displaying five competitor scores along with their corresponding skill levels such as:

| Position | Opponent | Score | Skill Score at Time |
|---|---|---|---|
| 1 | Player B | 4520 | 3200 |
| 2 | Player C | 4000 | 3150 |
| 3 | Player D | 3600 | 3100 |
| 4 | Player E | 2900 | 3050 |
| 5 | Player F | 2600 | 3000 |

Moreover, player A's finishes the game and submits a score of 3900. The leaderboard engine (206) animates the transition as player A is inserted into third place, displaying player D to fourth position on the leaderboard and a smooth transition shows player A onto a podium.

Since, player A is still within the first 10 games:

$$Average rolling score = k \times ( Score in game ) / rounded to integer$$

Let the previous scores of the player are 6000, 6300, 6300=Average=5625

$$New skill score = k \times 5625 = 0.5 \times 5625 = 2812$$

The player's skill score is saved in the profile database for future matchmaking purposes.

Furthermore, player A finished in third position, resulting in a return of 1× the entry fee of USD of 1. The winning is added to player A's wallet.

Moreover, the RTP optimization engine (214) monitors the player's winning at each tier. If players in Player A's winning are high or low, the matchmaking score bands are adjusted efficiently. Also, the score integrity engine (212) validates Player A's 3900 score against server logs, and if everything aligns, the score is stored in the player score database, and if player D remains beyond a predefined inactivity threshold detected via score decay engine (216) for reducing the influence of historical scores in skill score calculations.

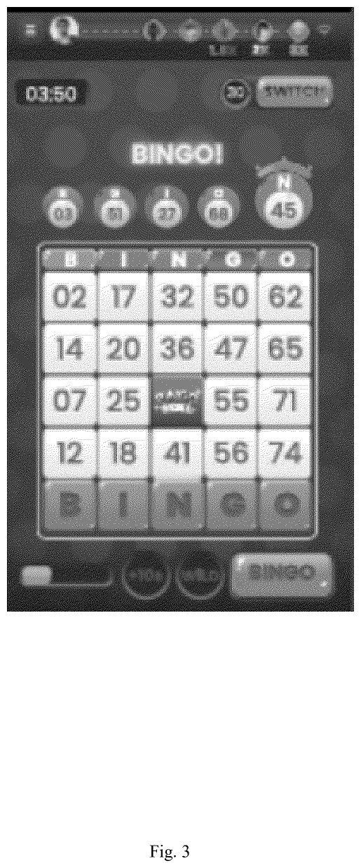

Referring to FIG. 3, illustrates a dynamic interface of a real-money skill-based gaming system (200). FIG. 3 discloses a player identification and status panel that reflects the players skill level, skill score, and number of games played. The icons refer an active boosters or multipliers (e.g., 1.5×, 2×, 3× winnings), which dynamically influence potential rewards or score visibility. Also, a game timer is disclosed which shows the time remaining for the player to complete the current game session, thereby ensuring fairness among all players on the same leaderboard cycle.

Moreover, a panel of balls are disclosed in the interface which at least five balls labeled under the Bingo letters which display the most recently called numbers. Also, a 5×5 Bingo grid is disclosed in the centered on a screen, the middle cell contains a “BINGO+SKILL” icon, representing a free or skill-enhanced tile, the rest of the grid shows numbered tiles, some of which are matched, and bottom row contains highlighted tiles spelling out “BINGO,” thereby indicating that the player has completed a row and achieved a win condition.

Furthermore, a footer controls disclosed at the bottom of the interface comprises a purple bar which indicates the players turn progress, a two booster buttons contains a +10 s″ for extra time and WILD, thereby representing a wildcard option and a BINGO confirmation button that the player must press to declare Bingo and lock in their final score.

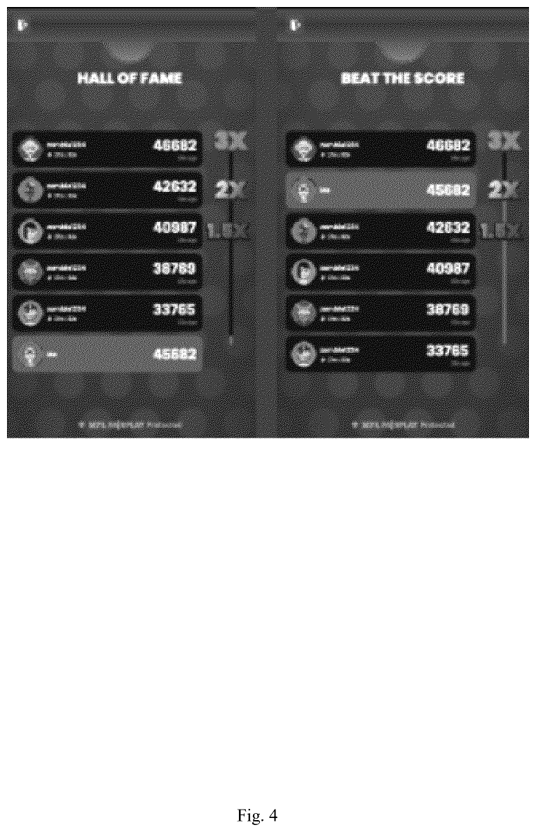

Referring to FIG. 4, illustrates a leaderboard interface of gameplay “hall-of-fame”. FIG. 4 discloses a leaderboard with six player scores. Each entry on the leaderboard includes a username, a score, and a timestamp indicating when the score is obtained (e.g., “15 s ago” or “17 m:32 s”). The player on the leaderboard is arranged in descending order of their scores from highest to lowest. The player's own entry, labeled “Me,” is highlighted and is at the bottom of the list and the player's score is 45682.

Moreover, the leaderboard interface discloses potential winnings as a multiplier of the entry fee, such as “3×” for the top score, “2×” for the second score, and “1.5×” for the third. The “hall-of-fame” interface discloses the player's current position relative to the other scores.

Furthermore, FIG. 4, illustrates a leaderboard interface of gameplay “Beat the Score” which is similar to the “hall-of-fame” interface. The player's entry, “Me,” with a score of 45682, is now placed in the second position, just below the highest score of 46682. The previous second-place score 42632 and all subsequent scores have been shifted down one position.

Moreover, the prize multipliers for the top three positions are the same as on the left screen (3×, 2×, and 1.5×). The player's winning position is clearly highlighted, thereby indicating the player beat plurality of opponents and are now in a prize-winning position.

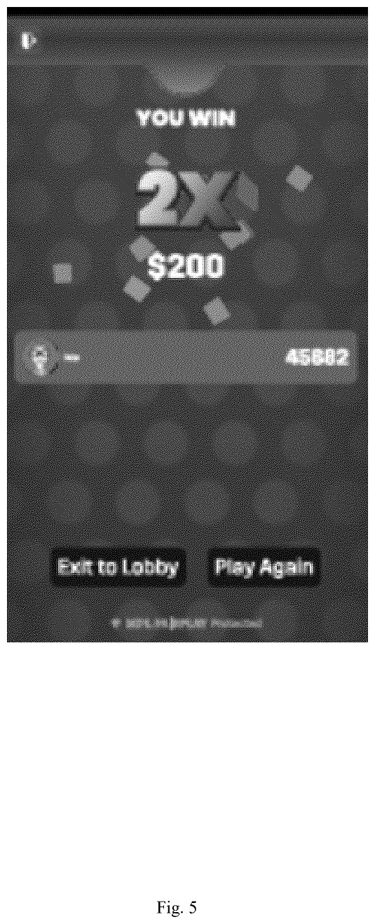

Referring to FIG. 5, illustrates a leaderboard interface of gameplay “You Win” which is disclosed at top of the interface. The center of the interface discloses a “2×” and “USD of 200” which indicates the player's winnings. The amount disclosed in the interface is a multiplier of the original entry fee.

Moreover, the player's avatar and username “Me” are displayed alongside their final score of 45682. Also, two buttons are at the bottom of the interface “Exit to Lobby” and “Play Again,” allowing the player to continue or end their session and the interface confirms the player's winning and the deposit of winnings reward into player wallet which is allotted before beginning of the gameplay.

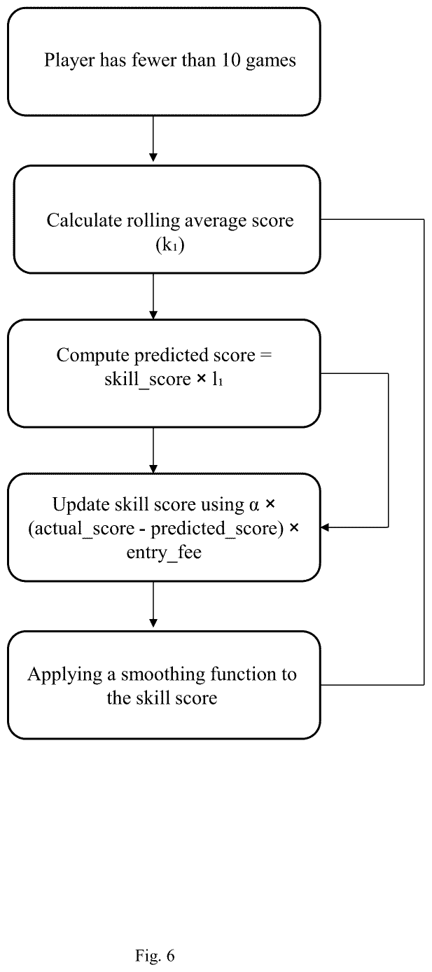

Referring to FIG. 6, a flow chart of a skill score update mechanism is disclosed. The flowchart shows that the system (200) is dynamically calculates and updates a player's skill score for players has fewer than 10 games. The system (200) calculates a rolling average scaled by a constant (k₁) to mitigate outliers. A predicted score is computed using the formula: predicted_score=skill_score×l₁.

Moreover, the skill score is updated by a formula that factors in the entry fee and deviation from the predicted score, scaled by a learning constant α. Then, the smoothing function is applied to avoid abrupt fluctuations, and if the player is inactive, a decay factor reduces the weight of old scores.

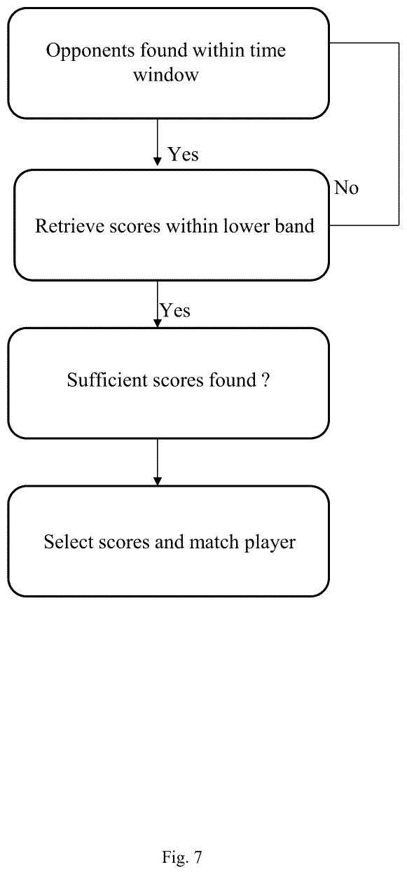

Referring to FIG. 7, a flow chart of a match band selection and fallback logic is disclosed. The flowchart explains that how the opponents are selected from historical scores for asynchronous matchmaking. The system (200) checks if opponents are available within a defined time window (T) to ensure recency and fairness. If opponents are found, then it first retrieves scores within a lower band (e.g., 0.8×-1.0× of predicted score) and similarly, if not enough scores are found in one band, then it falls back to the upper band (e.g., 1.0×-1.5×). The matchmaking bands are dynamically adjusted based on real-time analysis of return-to-player (RTP) metrics.

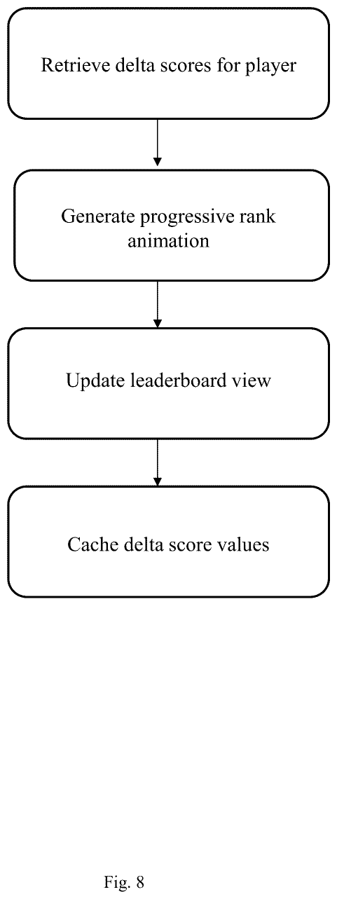

Referring to FIG. 8, a flow chart of a delta leaderboard rendering and caching strategy is disclosed. The flowchart shows how the leaderboard is displayed and updated via a progressive animation sequence which visually represents the rank changes using cached delta score values. The leaderboard is updated visually on the client, thereby reducing server load and latency, and supports reward distribution based on final rank, with rewards scaled by dynamic multipliers.

In one embodiment of the present invention, the present invention comprises core game flow, skill evaluation engine (208), matchmaking engine (204) and reward distribution engine (210).

### 1. Core Game Flow:

The game flow begins with a player paying a fixed entry fee to join a gameplay. The matchmaking engine (204) matches the player with five opponents who have a similar skill level. The scores of these opponents must have been obtained within the last 12 hours. The game is themed as a “hall-of-fame” where all players are on a podium, and potential winnings are clearly displayed next to the leaderboard positions. Post finishing the game, the player's score is updated as a function of their final score, user age, and entry fee. An animation shows the player being placed on the leaderboard according to the player's ranking, visually indicating their entry into the “hall-of-fame” and the winnings are then distributed directly into the player's wallet based on their final position.

Chart 1 herein refers to the game flow process as follows:

### 1. Skill Evaluation Engine.

In games like bingo/solitaire, the players play to maximize their score irrespective of the cash entry fee and the score of their opponents.

The skill evaluation engine (208) disclosed herein calculates skill score for new players in case of (w<=10 games) is different from the calculation for seasoned players (10 games).

In one scenario, the skill evaluation engine (208) calculates skill score for players w/ <=10 games. Players start with a default score of [3000] in the given scenario. After their first game, the skill score of the players=[k]×(score in game 1)//rounds to integer. [k] is a scaling constant that amplifies/dampens the score gradient. For each successive game, the skill score is updated to reflect their rolling average of score until they complete 10 games as [k]×(rolling average of score). Players cannot play at higher price points until they complete 10 games. Therefore, the skill_score after 10 games is their average score in first 10 games scaled by a constant.

In another scenario, the skill evaluation engine (208) calculates skill score calculation for players w/>10 games. Thus, the predicted_score is equal to skill_score×[1]. The term [1] is different from [k] as a balancing requirement. In initial stages, [1]=[k] figuring out base win-rates. Maximum entry fee of the players influences how the skill score is updated. Additionally, skill score updates differently based on actual score/predicted score using this flow ensures that players' skill values correct faster if there is a large deviation from predicted score, while preventing players from spoofing the score by playing at lower cash entry fees. Therefore, skill score still needs to be refined to prevent spoofing by players who throw games to reduce it.

The chart 2 herein refers to the game flow process as follows:

### 2. Matchmaking Engine:

As the player joins a match, their predicted score is given by skill score×{l] where [l] is a constant. The matchmaking engine (204) scans for scores submitted within the last [1 hour] window to find 2 scores within (0.8× and 1× predicted score) and 3 scores within (1× and 1.5× predicted score). The matchmaking engine (204) looks for the most recent scores within each bucket so that the experience feels near real-time. If the matchmaking engine (204) cannot find competitors within either score bucket, the matchmaking engine (204) checks to fill these slots with scores from the other bucket. If the matchmaking engine (204) cannot find scores within the given window (1 hour), the match is canceled, and the player receives a message to try again later. Thus, the important thing is to keep the score window constant at a lobby level so that the matchmaking engine (204) can reduce the window as much as the fail rates allow.

### 3. Reward Distribution Engine:

The leaderboard size is fixed for at least six entries for the initial launch period. The prize distribution can be set as a multiplier function on top of cash entry fee for each position. Also, the prize structure comprises a refund trigger module which refund the entry fees if score exceeds a threshold rank within selected prediction bands.

### Advantageous Effects of the Present Invention

In one embodiment of the present invention, the method and the system of the present invention that enables the players to play a leader board skill-based game.

Moreover, the present invention enables to calculate the skill score of the player based on player's performance in the prior games, and the cash entry fee of current tournament.

In a nutshell, the method and the system of the present invention overcome the drawbacks discussed in the conventional techniques and provided a cost effective and efficient way of playing a leader board skill-based game.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated.

It is understood that various omissions and substitutions of equivalents are contemplated as circumstances may suggest or render expedient, but such omissions and substitutions are intended to cover the application or implementation without departing from the spirit or scope of the present invention.

We claim:

1. A computer-implemented method (100) for asynchronous multiplayer matchmaking in a skill-based game environment, the method (100) comprising the steps of:
receiving (at step 102), via a network interface, an entry request from a client device, including an associated entry fee;
determining (at step 104) a predicted performance score for a player by dynamically computing a skill score, the skill score being updated using a combination of the player's historical average score and the deviation between actual and predicted performance;
retrieving (at step 106), from a time-restricted score database, a set of timestamped opponent scores submitted within a predefined time window, selected to fall within predefined bands around the predicted performance score;
generating (at step 108), on the client device, a real-time leaderboard instance including the player's rank and the ranks of matched opponents;
receiving (at step 110) the player's actual score from the client device after gameplay;
updating (at step 112) the player's skill score using an adaptive update function, wherein different update logic is applied based on whether the player has played more or fewer than a threshold number of games;
rendering (at step 114) a leaderboard update with a progressive animation reflecting the new ranking position; and
distributing (at step 116) a calculated reward to the player's wallet based on their final rank using a dynamic multiplier-based reward distribution logic;
wherein the method (100) ensures fair asynchronous gameplay by adapting opponent selection and leaderboard generation without requiring concurrent player participation.

2. The method (100) as claimed in claim 1, wherein the adaptive skill score update comprises:
for players with fewer than ten recorded games, calculating a rolling average of scores scaled by a constant factor (k₁) to mitigate outliers; and
for players with ten or more games, computing a predicted_score as predicted_score=skill_score×l₁, and updating the skill score using:
$$skill\_score \_new = skill\_score + α \times ( actual\_score - predicted\_score ) \times entry\_fee , where α is a learning rate constant .$$

3. The method (100) as claimed in claim 1, wherein the retrieval of opponent scores is constrained to a defined time window (T), and further comprising cancelling the matchmaking attempt if suitable scores are not identified within the time window T; or falling back to alternative score bands if no matches are available in the initial bands:
wherein, the time-window constraint mitigates fraudulent gameplay by ensuring opponent scores originate from recent and valid gameplay sessions.

4. The method (100) as claimed in claim 1, wherein access to high-entry-fee gameplay contests is restricted until the player has completed a predefined minimum number of games; and exhibits a skill score variance within a defined acceptable deviation range.

5. The method (100) as claimed in claim 1, wherein the leaderboard is updated using a progressive animation sequence that visually represents the rank changes using cached delta score values, thereby reducing the amount of data transmitted between server and client and minimizing latency.

6. The method (100) as claimed in claim 1, further comprising dynamically calculating prize rewards based on a fixed leaderboard size, wherein each position on the leaderboard is associated with a preconfigured multiplier; and the multiplier is applied to the player's entry fee to determine the reward amount; the prize structure is configured such that a player must beat a minimum number of opponents to recover their entry fee.

7. The method (100) as claimed in claim 1, further comprising reducing the effective weight of a player's historical scores in skill score computation when the player remains inactive beyond a predefined inactivity threshold, by applying a decay factor.

8. The method (100) as claimed in claim 1, wherein the matchmaking score bands are dynamically adjusted based on real-time analysis of return-to-player (RTP) metrics; and a predefined RTP target value for experienced players.

9. The method (100) as claimed in claim 1, further comprising thematically rendering the leaderboard as a hall-of-fame podium; associating each matched opponent score with a timestamp and corresponding skill level; and displaying an entry animation that visually represents the player displacing the lowest-ranked score on the leaderboard.

10. The method (100) as claimed in claim 1, further comprising detecting transitions in entry fee tiers for a player and applying a smoothing function to the skill score when the player first participates in a higher fee tier to reduce abrupt fluctuations.

11. A computer-implemented system (200) for asynchronous multiplayer matchmaking in a skill-based gaming environment, the system (200) comprising:
a player profile database (202) configured to store each player's skill score, gameplay history, and timestamped game scores;
a matchmaking engine (204) configured to:
compute a predicted score for a player based on the player's current skill score and a scaling factor;
retrieve historical opponent scores submitted within a predefined time window;
select opponent scores falling within two bands: a lower band (0.8×-1.0×) and an upper band (1.0×-1.5×) of the predicted score; and
fallback to the other band if insufficient scores are found in one band, and cancel the match if sufficient scores are not found in total;
a leaderboard engine (206) configured to:
generate a leaderboard view including the player and matched opponent scores; and
render progressive animation representing rank changes using minimal delta data;
a skill evaluation engine (208) configured to update player skill scores based on match outcomes using dynamic update logic; and
a reward distribution engine (210) configured to allocate winnings based on final leaderboard position and a multiplier function tied to entry fee.

12. The system (200) as claimed in claim 11, wherein the skill evaluation engine (208) is further configured to initialize a default skill score for new players; apply different update strategies based on a game count threshold; and scale updates according to actual score, predicted score, and entry fee, using a corrective learning constant.

13. The system (200) as claimed in claim 11, further comprising an RTP optimization engine (214) configured to monitor RTP metrics across player cohorts; and adjust matchmaking score bands dynamically to maintain RTP near a predefined target value.

14. The system (200) as claimed in claim 11, further comprising a score decay engine (216) configured to detect player inactivity beyond a defined threshold and apply a decay function to reduce the influence of historical scores in skill score calculations.

15. The system (200) as claimed in claim 11, further comprising a tiered access manager (218) configured to classify players into entry fee tiers based on skill score and gameplay count and regulate entry and transition between tiers based on win-rate, score variance, and consistency metrics.

16. The system (200) as claimed in claim 11, wherein the leaderboard engine (206) includes a user interface (UI) rendering module configured to display matched scores in a hall-of-fame podium layout; associate each score with timestamp and recorded skill level and animate player entry by displacing a lower-ranked opponent on the podium.

17. The system (200) as claimed in claim 11, further comprising a score integrity engine (212) which is configured to validate submitted player scores against server logs; flag statistically anomalous scores for manual review and to prevent storage of tampered scores in the database.

18. The system (200) as claimed in claim 11, further comprising a fraud detection engine (220) which is configured to compute an anomaly score for each submitted game session, wherein the anomaly score is derived from a combination of:
a timestamp compares submission time patterns with predefined time window for the player cohort, and
a gameplay pattern evaluates deviations in metrics such as player's performance, score rate and gameplay behavior.
